(19) United States
(12) Patent Application Publication
(10) Pub. No.: US 2005/0060538 A1
(43) Pub. Date: Mar. 17, 2005

(54) Method, system, and program for processing of fragmented datagrams

(75) Inventor: Harlan T. Beverly, McDade, TX (US)

Correspondence Address: KONRAD RAYNES VICTOR & MANN LLP, Suite 210, 315 S. Beverly Drive, Beverly Hills, CA, 90212, US

(73) Assignee: Intel Corporation

(21) Appl. No.: 10/663,178

(22) Filed: Sep. 15, 2003

(51) Int. Cl. H04L 9/00

(52) U.S. Cl. 713/160

(57) ABSTRACT

Provided are a method, system, and program for managing data reception processing using offload engines which may be located on a network adaptor. Data packets which become fragmented after encryption can be forwarded to a transport offload engine to be reassembled. The reassembled packets may be fed back to a security offload engine to be decrypted. The decrypted and reassembled packets may be forwarded again to the transport offload engine to extract the data payloads of the packets.

### BACKGROUND OF THE INVENTION

1. Field of the Invention

The present invention relates to a method, system, and program for managing data reception processing using offload engines.

2. Description of the Related Art

In a network environment, a network adaptor on a host computer, such as an Ethernet controller, Fibre Channel controller, etc., will receive Input/Output (I/O) requests or responses to I/O requests initiated from the host. Often, the host computer operating system includes a device driver to communicate with the network adaptor hardware to manage I/O requests to transmit over a network. Data packets received at the network adaptor would be stored in an available allocated packet buffer in the host memory. The host computer further includes a communication or transport protocol driver to process the packets received by the network adaptor that are stored in the packet buffer, and access any I/O commands or data embedded in the packet. For instance, the transport protocol driver may implement the Transmission Control Protocol (TCP) and Internet Protocol (IP) to decode and extract the payload data in the TCP/IP packets received at the network adaptor. IP specifies the format of packets, also called datagrams, and the addressing scheme. TCP is a higher level protocol which establishes a virtual connection between a destination and a source.

A device driver can utilize significant host processor resources to handle network transmission requests to the network adaptor. One technique to reduce the load on the host processor is the use of a TCP/IP Offload Engine (TOE) in which the TCP/IP protocol related operations are implemented in the network adaptor hardware as opposed to the device driver, thereby saving the host processor from having to perform the TCP/IP protocol related operations. The transport protocol operations include packaging data in a TCP/IP packet with a checksum and other information, and unpacking a TCP/IP packet received from over the network to access the payload or data.

Another transport protocol operation performed by a TOE may include reassembling packets from packet fragments. The size of a packet, typically measured in bytes, which the various nodes of a network can accommodate may vary from node to node. As a packet is sent from a source to a destination, the packet may encounter a node of the network which cannot accommodate the size of the packet. In those instances, the node can fragment the packet into smaller sized packets which are within the size limitations of the node. Each packet fragment is repackaged as a packet with the appropriate header and other information which will permit the packet fragments to be reassembled at the destination. This reassembly operation is often performed by the host processor at the destination but alternatively may be performed by a TOE or other auxiliary processor to relieve the host processor. The construction and operation of circuitry and programming to perform the operations of a transport layer are well understood by those skilled in the art.

Various protocols have also been developed to support secure exchange of data over a network. Once such protocol for encrypting packets at the IP layer is the IP Security (IPsec) protocol. IPsec supports various encryption modes including Transport Mode and Tunnel Model. The transport mode encrypts only the data portion (payload) of each packet, but leaves the header generally untouched. The more secure Tunnel mode encrypts both the header and the data portion. At the destination, an IPsec compliant device such as the host processor decrypts each packet. Alternatively, dedicated IPsec processors have been used. The construction and operation of circuitry and programming to perform these security operations are well understood by those skilled in the art.

Normally, upon receipt of a data packet (block 700, FIG. 7), the data packet is decrypted if previously encrypted (block 702) in accordance with the security protocol. Once decrypted, the data packets are reassembled (block 704) if the packets were fragmented during transmission over the network. A prior art network adaptor card may have a TOE to perform the reassembly and data payload extraction operations. However, if the data packets were fragmented during transmission after the packets were encrypted (block 706), the fragmented data packets are typically reassembled (block 708) by the host processor or other exception handling processors before being decrypted (block 702) and the transport layer processing is completed (block 704) by the TOE.

Notwithstanding, there is a continued need in the art to improve the performance of data reception processors and minimize processing burdens on the host processor.

### BRIEF DESCRIPTION OF THE DRAWINGS

Referring now to the drawings in which like reference numbers represent corresponding parts throughout:

FIG. 1 illustrates a computing environment in which aspects of the invention are implemented;

FIG. 2 illustrates a packet architecture used with embodiments of the invention;

FIG. 3 illustrates the packet of FIG. 2 fragmented into a plurality of packets and used with embodiments of the invention;

FIG. 4 illustrates a network adaptor in accordance with embodiments of the invention;

FIG. 5 illustrates operations performed to manage a receipt of data by the network adaptor in accordance with embodiments of the invention;

FIG. 6 illustrates an architecture that may be used with the described embodiments; and

FIG. 7 illustrates operations performed to manage a receipt of data by a prior art network adaptor and host processor.

### DETAILED DESCRIPTION OF THE PREFERRED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

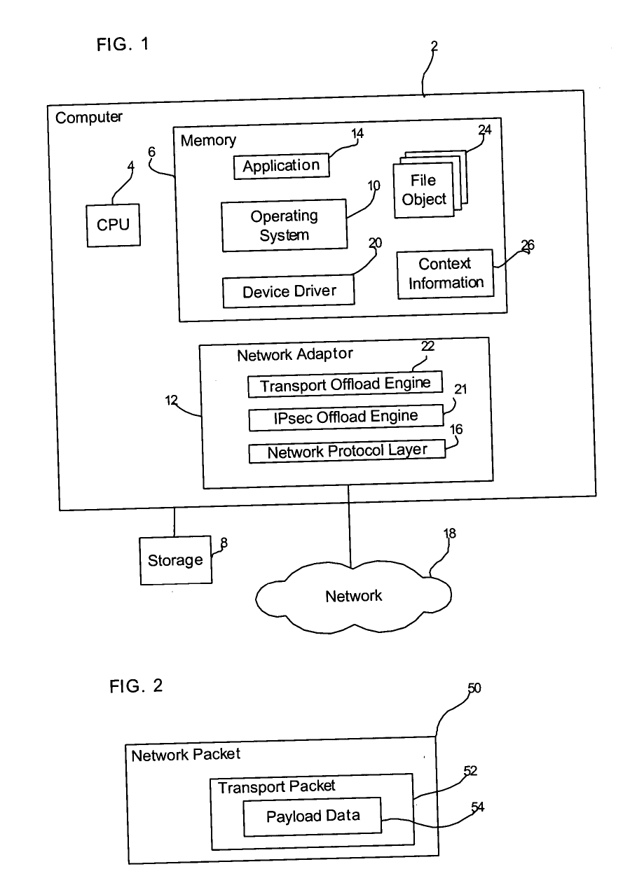

FIG. 1 illustrates a computing environment in which aspects of the invention may be implemented. A computer 2 includes one or more central processing units (CPU) 4 (only one is shown), a volatile memory 6, non-volatile storage 8, an operating system 10, and a network adaptor 12. An application program 14 further executes in memory 6 and is capable of transmitting and receiving packets from a remote computer. The computer 2 may comprise any computing device known in the art, such as a mainframe, server, personal computer, workstation, laptop, handheld computer, telephony device, network appliance, virtualization device, storage controller, etc. Any CPU 4 and operating system 10 known in the art may be used. Programs and data in memory 6 may be swapped into storage 8 as part of memory management operations.

The network adaptor 12 includes a network protocol layer 16 for implementing the physical communication layer to send and receive network packets to and from remote devices over a network 18. The network 18 may comprise a Local Area Network (LAN), the Internet, a Wide Area Network (WAN), Storage Area Network (SAN), etc. The embodiments may be configured to transmit data over a wireless network or connection, such as wireless LAN, Bluetooth, etc. In certain embodiments, the network adaptor 12 and network protocol layer 16 may implement the Ethernet protocol, token ring protocol, Fibre Channel protocol, Infiniband, Serial Advanced Technology Attachment (SATA), parallel SCSI, serial attached SCSI cable, etc., or any other network communication protocol known in the art.

A device driver 20 executes in memory 6 and includes network adaptor 12 specific commands to communicate with the network adaptor 12 and interface between the operating system 10 and the network adaptor 12. In certain implementations, the network adaptor 12 includes a security offload engine 21 and a transport offload engine 22 as well as the network protocol layer 16. In the illustrated embodiment, the network adaptor 12 implements an IPsec offload engine and a TCP/IP offload engine (TOE), in which transport layer and security operations are performed within the offload engines 21 and 22 implemented within the network adaptor 12 hardware, as opposed to the device driver 20. The network layer 16 handles network communication and provides received TCP/IP packets to the security offload engine 21 to decrypt the packets if encrypted. The transport offload engine 22 interfaces with the device driver 20 and performs additional transport protocol layer operations, such as processing the decrypted content of messages included in the packets received at the network adaptor 12 that are wrapped in a transport layer, such as TCP and/or IP, the Internet Small Computer System Interface (iSCSI), Fibre Channel SCSI, parallel SCSI transport, or any other transport layer protocol known in the art. The transport offload engine 22 can unpack the payload from the received TCP/IP packet and transfer the data to the device driver 20 to return to the application 14.

Further, an application 14 transmitting data can transmit the data to the device driver 20, which can then send the data to the transport offload engine 22 to be packaged in a TCP/IP packet. The security offload engine 21 can encrypt the packet before transmitting it over the network 18 through the network protocol layer 16.

The memory 6 further includes file objects 24, which also may be referred to as socket objects, which include information on a connection to a remote computer over the network 18. The application 14 uses the information in the file object 24 to identify the connection. The application 14 would use the file object 24 to communicate with a remote system. The file object 24 may indicate the local port or socket that will be used to communicate with a remote system, a local network (IP) address of the computer 2 in which the application 14 executes, how much data has been sent and received by the application 14, and the remote port and network address, e.g., IP address, with which the application 14 communicates. Context information 26 comprises a data structure including information the device driver 20 maintains to manage requests sent to the network adaptor 12 as described below.

FIG. 2 illustrates a format of a network packet 50 received at the network adaptor 12. The network packet 50 is implemented in a format understood by the network protocol 14, such as encapsulated in an Ethernet frame that would include additional Ethernet components, such as a header and error checking code (not shown). A transport packet 52 is included in the network packet 50. The transport packet may 52 comprise a transport layer capable of being processed by the transport protocol driver 22, such as the TCP and/or IP protocol, Internet Small Computer System Interface (iSCSI) protocol, Fibre Channel SCSI, parallel SCSI transport, etc. The transport packet 52 includes payload data 54 as well as other transport layer fields, such as a header and an error checking code. The payload data 52 includes the underlying content being transmitted, e.g., commands, status and/or data. The operating system 10 may include a device layer, such as a SCSI driver (not shown), to process the content of the payload data 54 and access any status, commands and/or data therein.

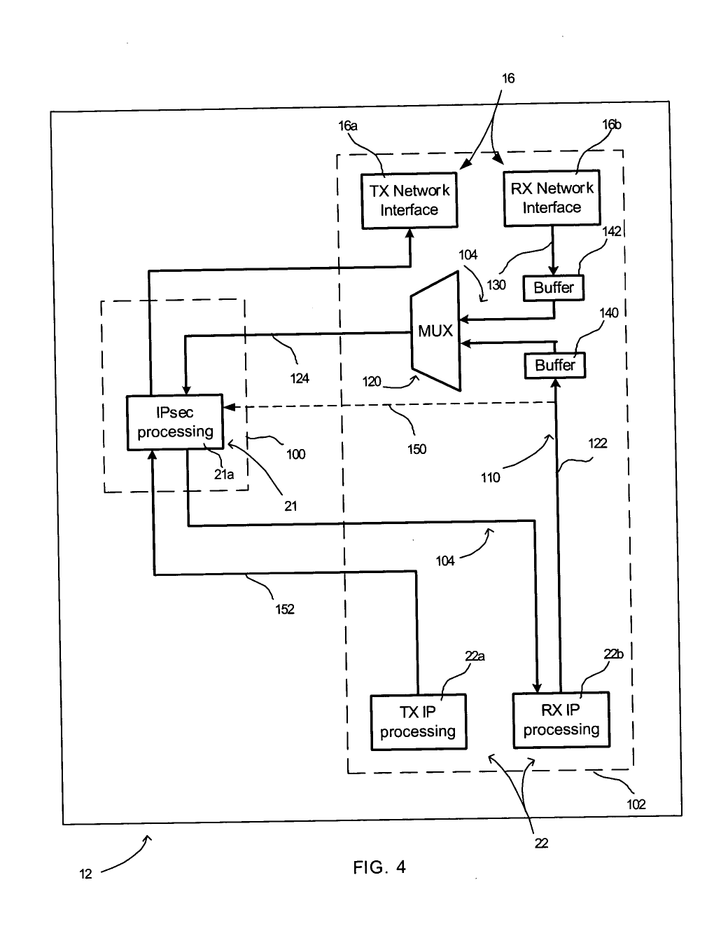

FIG. 4 shows an example of a network adaptor 12 having a network protocol layer 16 which includes a transmitter network interface 16a for sending data packets over the network 18 (FIG. 1) to remote devices. A receiver network interface 16b of the network protocol layer 16 receives data packets from the remote devices. The network interfaces 16a and 16b implement the physical communication layer for data transmission and reception over the network 18.

The security offload engine 21 includes an IPsec processing logic 21a which decrypts the packets received from the receiver network interface 16b if encrypted. The IPsec processing logic 21a also can encrypt data packets received from a transmitter IP processing logic 22a of the transport offload engine 22 prior to sending the data packets to the network 18 through the transmitter network interface 16a. The transmitter IP processing logic 22a wraps the payload data 54 (FIG. 2) into a transport packet 52 prior to sending the packet 52 to be encrypted by the IPsec processing logic 21a. The transport off load engine 22 further includes a receiver IP processing logic 22b which processes the decrypted content of messages included in the packets received at the network adaptor 12 that are wrapped in a transport layer.

In the illustrated embodiment, the IPsec processing logic 21a is implemented in an integrated circuit 100 and the network interfaces 16a, 16b and IP processing logic 22a and 22b are implemented in a separate integrated circuit 102. It is appreciated that these processing logic elements may be implemented in a single integrated circuit or more than two integrated circuits, depending upon the application. These integrated circuits may comprise dedicated logic circuitry, programmed processors or various combinations of software and hardware, which may be, for example, separate from the host CPU 4 and host memory 6. However, portions of the logic such as the IPsec processing logic 21a may be implemented by the device driver 20 or other software executing in the host memory 6. Still further, in some embodiments, the IP processing logic 22a, 22b and the network interfaces 16a, 16b can pass data packets directly to each other, bypassing the IPsec processing logic 21a where IPsec processing is not needed.

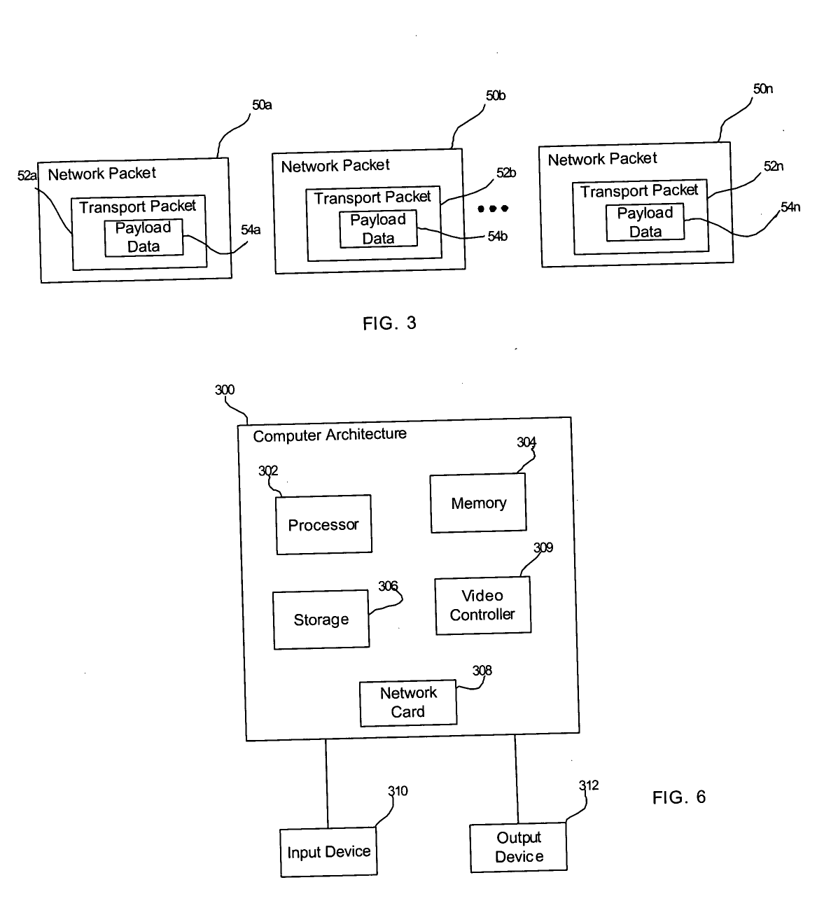

The network adaptor 12 includes a feedforward path 104 which permits data to flow from the network interface receiver 16b, through the IPsec processing logic 21a and to the receiver IP processing logic 22b. In accordance with aspects of the illustrated embodiments, the network adaptor 12 includes a feedback path 110 from the transport offload engine 22 to the security offload engine 21 which can facilitate increased processing of received data packets by the network adaptor 12 instead of the host or other processors. More specifically, it is appreciated that instances may arise in which processing of received packets which has previously been performed by the host CPU 4 may instead be performed by the transport offload engine 22. For example, if a packet such as the packet 50 of FIG. 2 is encrypted and then fragmented by a network node during transmission over the network into a plurality of fragments 50a, 50b . . . 50n; 52a, 52b . . . 52n; and 54a, 54b . . . 54n, (FIG. 3), the security offload engine 22 may not, in certain applications, be designed to decrypt the fragments 52a, 52b . . . 52n before the fragments are reassembled as the encrypted packet 52.

In such circumstances, the encrypted fragments 52a, 52b . . . 52n may be forwarded to the receiver IP processing logic 22b of the transport offload engine 22 of the network adaptor 12 to be reassembled back into the unfragmented encrypted packet 52. The reassembled packet 52 may then be passed back via the feedback path 110 to the IPsec processing logic 21a of the security offload engine 21 to be decrypted. Following decryption, the packet 52 may be forwarded again to the receiver IP processing logic 22b of the transport offload engine 22 to complete the transport layer processing including unpacking the TCP/IP packet 52 to access the payload or data 54.

In the illustrated embodiment, the feedback path 110 passes through a multiplexer 120 which selectively couples data from either the feedback path 110 from the output 122 of the receiver IP processing logic 22b to the input 124 of the IPsec processing logic 21a or alternatively the feedforward path 104 from the output 130 of the receiver network interface 16b to the input 124 of the IPsec processing logic 21a. In one embodiment, the multiplexer 120 is an “un-interrupting” implementation in which a flow of data forming a contiguous data packet from either the receiver network interface 16b or from the receiver IP processing logic 22b is not typically interrupted. For example, if a packet of data is available at the output 130 of the receiver network interface 16b, and no data from the output 122 of the receiver IP processing logic 22b is available, the data packet from the receiver network interface 16b is forwarded through the multiplexer 120 to the IPsec processing logic 21a for processing. This would be a typical flow of data when reassembled fragments are not being passed back via the feedback path 110.

Furthermore, if the receiver network interface 16b is transferring a data packet to the IPsec processing logic 21a via the multiplexer 110, and a data packet from the IP processing logic 22b becomes available for transfer to the IPsec processing logic 21a, the multiplexer 110, in the illustrated embodiment, will wait until the transfer of the data packet from the receiver network interface 16b to the IPsec processing logic 21a is complete before permitting transfer of a data packet from the IP processing logic 22b.

To reduce the dropping of data packets, a buffer 140 may be provided in the feedback path 110 or in the receiver IP processing logic 22b to buffer data packets when the multiplexer 120 is closed to the receiver IP processing logic 22b. Also, the receiver IP processing logic 22b can be designed or programmed to hold off feeding reassembled packets back to the IPsec processing logic 21a until the input 124 becomes available.

Conversely, if a packet of data is available at the output 122 of the receiver IP processing logic 22b, and no data from the output 122 of the receiver network interface 16b is available, the data packet from the receiver IP processing logic 22b is forwarded through the multiplexer 120 to the IPsec processing logic 21a for processing.

Furthermore, if the receiver IP processing logic 22b is transferring a data packet to the IPsec processing logic 21a via the multiplexer 120, and a data packet from the receiver network interface 16b becomes available for transfer to the IPsec processing logic 21a, the multiplexer 110, in the illustrated embodiment, will wait until the transfer of the data packet from the receiver IP processing logic 22b to the IPsec processing logic 21a is complete before permitting a transfer of a data packet from the receiver network interface 16b.

To reduce the dropping of data packets, a buffer 142 may be provided in the output of the receiver network interface 16b to buffer data packets when the multiplexer 120 is closed to the receiver network interface 16b. Also, the receiver network interface 16b can be designed or programmed to hold off sending packets to the IPsec processing logic 21a until the input 124 becomes available. To reduce the effects of packet dropping, in one embodiment, the receiver network interface 16b can be designed or programmed to drop only packets which are bound for the IPsec processing logic 21a. Accordingly, by interpreting the IPsec headers of the packets, the packets can be classified as to whether IPsec processing is needed. If not, packets can be forwarded directly to the transport processing logic 22b via a separate path (not shown).

It is appreciated that other types of feedback paths, multiplexers, buffering techniques, and data waiting techniques may be used, depending upon the particular application. For example, instead of a using a multiplexer 120 or other circuit to selectively couple one of the outputs 122 and 130 to the IPsec processing input 124, the output 122 of the receiver IP processing logic 22b may be coupled directly to a separate input 150 (indicated in phantom line in FIG. 4) of the IPsec processing logic 21. In yet another alternative, the output 152 of the transmitter IP processing logic 22a to the IPsec processing logic 21a normally used to transfer data packets to the IPsec processing logic for encryption prior to sending over the network, may also be used to pass back reassembled data packets for decryption by the IPsec processing logic 21a.

In such an embodiment, the reassembled data packets may be provided a tag to indicate that the reassembled data packets should be treated as received data packets which are to be processed as such by the IPsec processing logic 21a and returned to the receiver IP processing logic 22b instead of being passed on to the transmitter network interface 16a for transmission through the network. Also, instead of a tag, a suitable control can be designed or programmed into the network adaptor 12 to indicate that the reassembled data packets are to be treated by the IPsec processing logic 21a as received data packets rather than data packets to be transmitted.

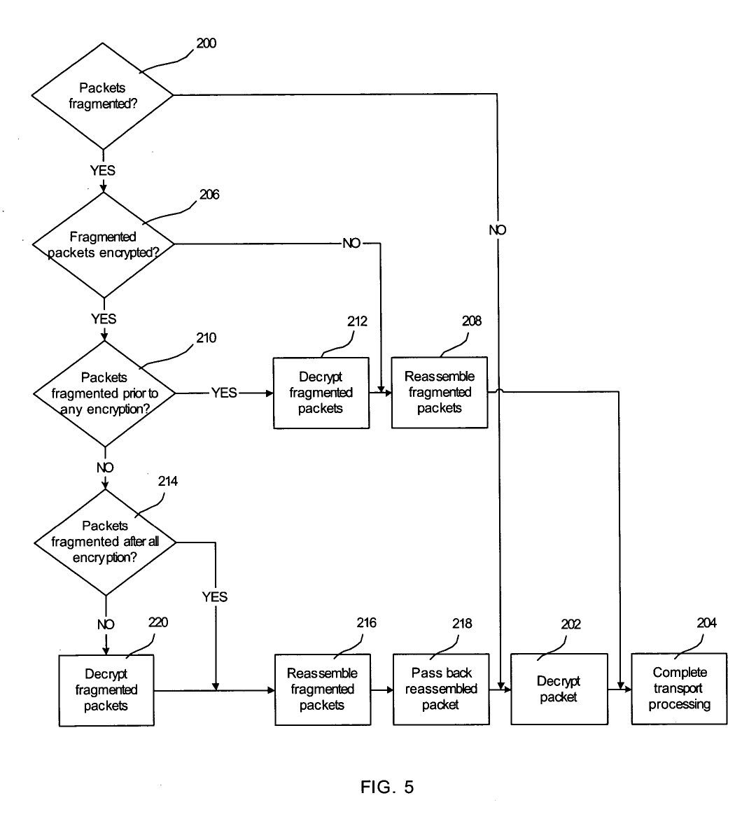

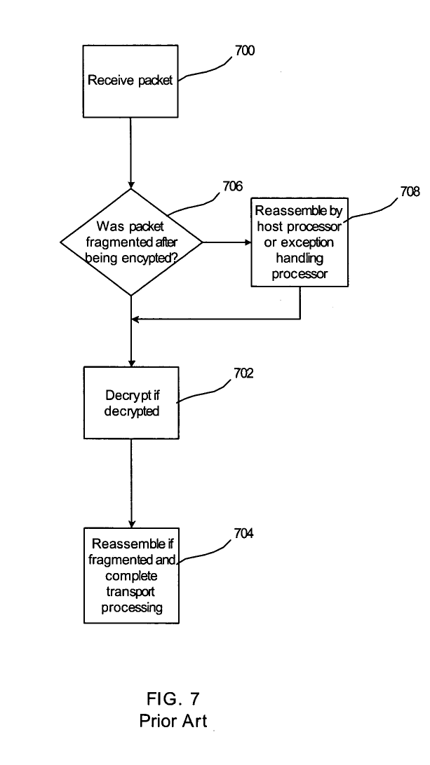

FIG. 5 illustrates operations performed by the network adaptor 12 to process received packets. A received packet is passed by the receiver network interface 16b through the multiplexer 120 to the IPsec processing logic 21a. If the received packet is not fragmented (block 200), the IPsec processing logic 21a decrypts (block 202) the received packet if encrypted. The decrypted packet is then passed to the receiver IP processing logic 22b of the transport offload engine 22 to complete (block 204) the transport layer processing (block 204). This transport layer processing can include error checking and unpacking data payloads. If the received packet is not encrypted or fragmented, the receiver network interface 16b can alternatively pass the received packet directly to the IP processing logic 22b.

If the received packet is fragmented (block 200), the IPsec processing logic 21a determines whether the fragmented packet is encrypted (block 206). If not, the fragmented packet is passed to the receiver IP processing logic 22b of the transport offload engine 22 to be reassembled (block 208) and to complete the transport layer processing (block 204). If the received packet is fragmented (block 200) and encrypted (block 206), the IPsec processing logic 21a determines whether the fragmented and encrypted packet was fragmented prior to the encryption (block 210). If the packet was fragmented prior to encryption, the IPsec processing logic 21a decrypts (block 212) the received packet. The fragmented and decrypted packet is then passed to the receiver IP processing logic 22b of the transport offload engine 22 to be reassembled (block 208) and to complete the transport layer processing (block 204).

If the received packet is fragmented (block 200) and encrypted (block 206), and the IPsec processing logic 21a determines that the fragmented and encrypted packet was fragmented after encryption (block 210), the IPsec processing logic 21a determines whether all fragmentation occurred after the encryption (block 214). In accordance with the illustrated embodiment, if all fragmentation occurred after the encryption, the fragmented and encrypted packet can be passed to the receiver IP processing logic 22b of the transport offload engine 22 to be reassembled (block 216). The receiver IP processing logic 22b can then pass (block 218) the reassembled and encrypted packet back to the IPsec processing logic 21a via the feedback path 110 (or an alternate route as discussed above). The IPsec processing logic 21a decrypts (block 202) the packet. The reassembled and decrypted packet is then passed forward to the receiver IP processing logic 22b of the transport offload engine 22 to complete the transport layer processing (block 204).

As previously mentioned, the IPsec Protocol supports various encryption modes including Transport Mode and Tunnel Mode. The transport mode encrypts only the data portion (payload) of each packet, but leaves the header generally untouched. The more secure Tunnel mode encrypts both the header and the data portion. It is appreciated that packets may in some instances become encrypted in both modes. For example, a transport mode encrypted connection may have been established between a remote host and the host 2 (FIG. 1). In addition, a tunnel mode encryption connection may have been established between intermediate points of the connection between the remote host and the host 2. In such a situation, a tunnel mode encryption connection is running on top of a transport mode encryption connection. Thus, a packet traveling between the remote host, through the tunneling router and then to the host 2 would undergo two encryption operations (transport and tunnel modes) and would need a tunnel mode decryption operation followed by a transport mode decryption operation at the host 2.

If the packet was fragmented prior to both the transport mode and the tunnel mode encryptions, the IPsec processing logic 21a performs both a tunnel mode decryption and a transport mode decryption (block 212) of the fragmented packet. The fragmented and decrypted packet is then passed to the receiver IP processing logic 22b of the transport offload engine 22 to be reassembled (block 208) and to complete the transport layer processing (block 204).

If fragmentation occurred after both the tunnel mode encryption and the transport mode encryption, the fragmented and tunnel and transport mode encrypted packet can be passed to the receiver IP processing logic 22b of the transport offload engine 22 to be reassembled (block 216). The receiver IP processing logic 22b can then pass (block 218) the reassembled and encrypted packet back to the IPsec processing logic 21a via the feedback path 110 (or an alternate route as discussed above). The IPsec processing logic 21a performs both a tunnel mode decryption and a transport mode decryption (block 212) of the reassembled packet. The reassembled and decrypted packet is then passed forward to the receiver IP processing logic 22b of the transport offload engine 22 to complete the transport layer processing (block 204).

If fragmentation did not occur after all encryption (block 214), that is, if fragmentation occurred for example, after the transport mode encryption but before the tunnel mode encryption, the fragmented and tunnel and transport mode encrypted packet is tunnel mode decrypted (block 220) by the IPsec processing logic 21a. The fragmented tunnel mode decrypted and transport mode encrypted packet can be passed to the receiver IP processing logic 22b of the transport offload engine 22 to be reassembled (block 216). The receiver IP processing logic 22b can then pass (block 218) the reassembled and transport mode encrypted packet back to the IPsec processing logic 21a via the feedback path 110 (or an alternate route as discussed above). The IPsec processing logic 21a performs a transport mode decryption (block 202) of the reassembled packet. The reassembled and fully decrypted packet is then passed forward to the receiver IP processing logic 22b of the transport offload engine 22 to complete the transport layer processing (block 204). A packet in which fragmentation occurred after a tunnel mode encryption but before a transport mode encryption may be handled in a similar fashion.

### Additional Embodiment Details

The described techniques for processing received data in a network adaptor or network interface card may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

In the described embodiments, the transport offload engine was described as performing various transport layer operations in accordance with the TCP/IP Protocol. In alternative embodiments, data may be transmitted from a remote host to the host using other protocols. As such, a communication protocol offload engine such as the transport offload engine 22 would perform some or all of those transmission operations including fragmented data reassembly or data payload extraction in accordance with such other transmission protocols.

In the described embodiments, examples of various encryption modes were provided including the Transport Mode and Tunnel Mode supported by the IPsec Protocol. In alterative embodiments, data may be encrypted for transmission using modes and security protocols other than those of the IPsec Protocol. Thus, the security offload engine would decrypt data in accordance with such other security protocols.

In the described embodiments, certain operations were described as being performed by the device driver 20, security offload engine 21 and transport offload engine 22. In alterative embodiments, operations described as performed by the device driver 20 may be performed by the transport offload engine 22, and vice versa. Similarly, operations described as performed by the device driver 20 may be performed by the security offload engine 21, and vice versa.

In the described implementations, the transport protocol layer was implemented in the network adaptor 12 hardware which includes logic circuitry separate from the central processing unit or units 4 of the host computer 2. In alternative implementations, portions of the transport protocol layer may be implemented in the device driver or host memory 6.

In the described implementations, the security encryption and decryption functions were implemented in the network adaptor 12 hardware which includes logic circuitry separate from the central processing unit or units 4 of the host computer 2. In alternative implementations, portions of the security functions be implemented in the device driver or host memory 6.

In certain implementations, the device driver and network adaptor embodiments may be included in a computer system including a storage controller, such as a SCSI, Integrated Drive Electronics (IDE), Redundant Array of Independent Disk (RAID), etc., controller, that manages access to a non-volatile storage device, such as a magnetic disk drive, tape media, optical disk, etc. Such computer systems often include a desktop, workstation, server, mainframe, laptop, handheld computer, etc. In alternative implementations, the network adaptor embodiments may be included in a system that does not include a storage controller, such as certain hubs and switches.

In certain implementations, the network adaptor may be configured to transmit data across a cable connected to a port on the network adaptor. Alternatively, the network adaptor embodiments may be configured to transmit data over a wireless network or connection, such as wireless LAN, Bluetooth, etc.

The illustrated logic of FIG. 5 shows certain events occurring in a certain order. In alternative embodiments, certain operations may be performed in a different order, modified or removed. Morever, steps may be added to the above described logic and still conform to the described embodiments. Further, operations described herein may occur sequentially or certain operations may be processed in parallel. Yet further, operations may be performed by a single processing unit or by distributed processing units.

FIG. 6 illustrates one implementation of a computer architecture 300 of the network components, such as the hosts and storage devices shown in FIG. 1. The architecture 300 may include a processor 302 (e.g., a microprocessor), a memory 304 (e.g., a volatile memory device), and storage 306 (e.g., a non-volatile storage, such as magnetic disk drives, optical disk drives, a tape drive, etc.). The storage 306 may comprise an internal storage device or an attached or network accessible storage. Programs in the storage 306 are loaded into the memory 304 and executed by the processor 302 in a manner known in the art. The architecture further includes a network card 308 to enable communication with a network, such as an Ethernet, a Fibre Channel Arbitrated Loop, etc. Further, the architecture may, in certain embodiments, include a video controller 309 to render information on a display monitor, where the video controller 309 may be implemented on a video card or integrated on integrated circuit components mounted on the motherboard. As discussed, certain of the network devices may have multiple network cards. An input device 310 is used to provide user input to the processor 302, and may include a keyboard, mouse, pen-stylus, microphone, touch sensitive display screen, or any other activation or input mechanism known in the art. An output device 312 is capable of rendering information transmitted from the processor 302, or other component, such as a display monitor, printer, storage, etc.

The network adaptor 12, 308 may be implemented on a network card, such as a Peripheral Component Interconnect (PCI) card or some other I/O card, or on integrated circuit components mounted on the motherboard.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. A method for processing data packets sent through a network, comprising:
receiving data packets from a host through the network wherein the received packets were, prior to receipt, encrypted and fragmented after encryption;
reassembling the fragmented packets using a communication protocol offload engine in a network adaptor coupling a host central processing unit to the network;
decrypting the reassembled packets of encryption using a security offload engine in the network adaptor; and
forwarding the decrypted and reassembled packets to the communication protocol offload engine.

2. The method of claim 1 further comprising:
receiving from a remote host through the network additional packets which were encrypted in a first encryption, fragmented after the first encryption and encrypted in a second encryption after the fragmentation;
decrypting the fragmented packets of the second encryption of using the security offload engine;
reassembling the fragmented packets decrypted of the second encryption using a communication protocol offload engine;
decrypting the reassembled packets of the first encryption using the security offload engine; and
forwarding the decrypted and reassembled additional packets to the communication protocol offload engine.

3. The method of claim 1, further comprising:
receiving from a remote host through the network additional packets which were encrypted and fragmented after all encryption;
reassembling the fragmented additional packets using the communication protocol offload engine;
decrypting the reassembled additional packets of encryption using the security offload engine; and
forwarding the decrypted and reassembled additional packets to the communication protocol offload engine.

4. The method of claim 1, further comprising:
receiving from a remote host through the network additional packets which were fragmented and then encrypted;
decrypting the fragmented additional packets of encryption using the security offload engine; and
reassembling the fragmented and decrypted additional packets using the communication protocol offload engine.

5. The method of claim 1, further comprising:
receiving from a remote host through the network additional packets which were fragmented but not encrypted;
reassembling the fragmented and unencrypted packets using the communication protocol offload engine.

6. The method of claim 1, further comprising:
receiving from a remote host through the network additional packets which were encrypted but not fragmented;
decrypting the unfragmented packets of encryption using the security offload engine; and
forwarding the decrypted additional packets to the communication protocol offload engine.

7. The method of claim 2, wherein the first encryption is a transport mode encryption and the second encryption is a tunnel mode encryption.

8. The method of claim 1, further comprising:
feeding the received packets through a feedforward path from a network interface receiver in the network adaptor, through the security offload engine and to the communication protocol offload engine to be reassembled; and
feeding the reassembled packets from the communication protocol offload engine through a feedback path from the communication protocol offload engine to the security offload engine to be decrypted.

9. The method of claim 8, wherein said forwarding comprises:
feeding the decrypted and reassembled packets through the feedforward path from the security offload engine to the communication protocol offload engine; said method further comprising:
extracting a data payload from the decrypted and reassembled packets using the communication protocol offload engine.

10. The method of claim 8, further comprising:
multiplexing a flow of data packets in the feedforward path from the network interface receiver to the security offload engine and a flow of data packets in the feedback path from the communication protocol offload engine to the security offload engine.

11. A network adaptor for use with a network, comprising:
a security offload engine having an input and an output and adapted to decrypt encrypted packets;
a communication protocol offload engine having an input and an output and adapted to reassemble fragmented packets;
a network interface receiver having an output coupled to the security offload engine input and an input adapted to receive from the network packets which were, prior to receipt, encrypted and fragmented after encryption;
a feedforward path coupling said receiver output to said security offload engine input and said security offload engine output to said communication protocol offload engine input;
a feedback path coupling said communication protocol offload engine output to said security offload engine input; and
logic adapted to feed the fragmented packets from the network interface receiver through the feedforward path to the communication protocol offload engine to be reassembled in the communication protocol offload engine, to feed the reassembled packets from the communication protocol offload engine through the feedback path to the security offload engine to be decrypted in the security offload engine, and to feed the decrypted and reassembled packets from the security offload engine, through the feedforward path to the communication protocol offload engine.

12. The adaptor of claim 11:
wherein said receiver is adapted to receive from the network additional packets which were encrypted in a first encryption, fragmented after the first encryption and encrypted in a second encryption after the fragmentation; and
wherein the logic is adapted to to feed the fragmented packets of the second encryption from the network interface receiver through the feedforward path to the security offload engine to be decrypted of the second encryption in the security offload engine; to feed the fragmented packets decrypted of the second encryption from the security offload engine through the feedforward path to the communication protocol offload engine to be reassembled in the communication protocol offload engine, to feed the reassembled packets of the first encryption from the communication protocol offload engine through the feedback path to the security offload engine to be decrypted of the first encryption in the security offload engine, and to feed the decrypted and reassembled additional packets packets from the security offload engine, through the feedforward path to the communication protocol offload engine.

13. The adaptor of claim 11:
wherein said receiver is adapted to receive from the network additional packets which were encrypted and fragmented after all encryption; and
wherein the logic is adapted to to feed the fragmented additional packets from the network interface receiver through the feedforward path to the communication protocol offload engine to be reassembled in the communication protocol offload engine, to feed the reassembled additional packets from the communication protocol offload engine through the feedback path to the security offload engine to be decrypted in the security offload engine, and to feed the decrypted and reassembled additional packets packets from the security offload engine, through the feedforward path to the communication protocol offload engine.

14. The adaptor of claim 11:
wherein said receiver is adapted to receive from the network additional packets which were fragmented and then encrypted; and
wherein the logic is adapted to to feed the fragmented additional packets from the network interface receiver through the feedforward path to the security offload engine to be decrypted in the security offload engine, and to feed the decrypted additional packets packets from the security offload engine, through the feedforward path to the communication protocol offload engine.

15. The adaptor of claim 11:
wherein said receiver is adapted to receive from the network additional packets which were fragmented but not encrypted; and
wherein the logic is adapted to to feed the fragmented additional packets from the network interface receiver through the feedforward path to the communication protocol offload engine to be reassembled in the communication protocol offload engine.

16. The adaptor of claim 11:
wherein said receiver is adapted to receive from the network additional packets which were encrypted but not fragmented; and
wherein the logic is adapted to to feed the encrypted additional packets from the network interface receiver through the feedforward path to the security offload engine to be decrypted of the encryption in the security offload engine, and to feed the decrypted and additional packets packets from the security offload engine, through the feedforward path to the communication protocol offload engine.

17. The adaptor of claim 12 wherein the first encryption is a transport mode encryption and the second encryption is a tunnel mode encryption.

18. The adaptor of claim 111 the communication protocol offload engine is adapted to extracting a data payload from the decrypted and reassembled packets.

19. The adaptor of claim 11 wherein the feedback path and the feedforward path includes a multiplexor adapted to multiplex a flow of data packets in the feedforward path from the network interface receiver output to the security offload engine input and a flow of data packets in the feedback path from the communication protocol offload engine output to the security offload engine input.

20. The adaptor of claim 11 wherein the feedback path includes a buffer wherein said logic is adapted to store reassembled packets from the communication protocol offload engine to await multiplexing by said multiplexor to the security offload engine input.

21. A system for use with a network, comprising:
a system memory;
a processor coupled to the system memory;
data storage coupled to the processor and the system memory;
a data storage controller adapted to manage Input/Output (I/O) access to the data storage; and
a network adaptor which includes:
a security offload engine coupled to the memory and having an input and an output and adapted to decrypt encrypted packets;
a communication protocol offload engine having an input and an output and adapted to reassemble fragmented packets;
a network interface receiver having an output coupled to the security offload engine input and an input adapted to receive from the network packets which were, prior to receipt, encrypted and fragmented after encryption;
a feedforward path coupling said receiver output to said security offload engine input and said security offload engine output to said communication protocol offload engine input;
a feedback path coupling said communication protocol offload engine output to said security offload engine input; and
logic adapted to feed the fragmented packets from the network interface receiver through the feedforward path to the communication protocol offload engine to be reassembled in the communication protocol offload engine, to feed the reassembled packets from the communication protocol offload engine through the feedback path to the security offload engine to be decrypted in the security offload engine, and to feed the decrypted and reassembled packets from the security offload engine, through the feedforward path to the communication protocol offload engine.

22. An article of manufacture for use with a network wherein the article of manufacture causes operations to be performed, the operations comprising:
receiving data packets from a remote host through the network wherein the received packets were, prior to receipt, encrypted and fragmented after encryption;
reassembling the fragmented packets using a communication protocol offload engine in a network adaptor coupling a host central processing unit to the network;
decrypting the reassembled packets of encryption using a security offload engine in the network adaptor; and
forwarding the decrypted and reassembled packets to the communication protocol offload engine.

23. The article of manufacture of claim 22, wherein the operations further comprise:
receiving from a remote host through the network additional packets which were encrypted in a first encryption, fragmented after the first encryption and encrypted in a second encryption after the fragmentation;
decrypting the fragmented packets of the second encryption of using the security offload engine;
reassembling the fragmented packets decrypted of the second encryption using a communication protocol offload engine;
decrypting the reassembled packets of the first encryption using the security offload engine; and
forwarding the decrypted and reassembled additional packets to the communication protocol offload engine.

24. The article of manufacture of claim 22, wherein the operations further comprise:
receiving from a remote host through the network additional packets which were encrypted and fragmented after all encryption;
reassembling the fragmented additional packets using the communication protocol offload engine;
decrypting the reassembled additional packets of encryption using the security offload engine; and
forwarding the decrypted and reassembled additional packets to the communication protocol offload engine.

25. The article of manufacture of claim 22, wherein the operations further comprise:
receiving from a remote host through the network additional packets which were fragmented and then encrypted;
decrypting the fragmented additional packets of encryption using the security offload engine; and
reassembling the fragmented and decrypted additional packets using the communication protocol offload engine.

26. The article of manufacture of claim 22, wherein the operations further comprise:
receiving from a remote host through the network additional packets which were fragmented but not encrypted;
reassembling the fragmented and unencrypted packets using the communication protocol offload engine.

27. The article of manufacture of claim 22, wherein the operations further comprise:
receiving from a remote host through the network additional packets which were encrypted but not fragmented;
decrypting the unfragmented packets of encryption using the security offload engine; and
forwarding the decrypted additional packets to the communication protocol offload engine.

28. The article of manufacture of claim 23, wherein the first encryption is a transport mode encryption and the second encryption is a tunnel mode encryption.

29. The article of manufacture of claim 22, wherein the operations further comprise:
feeding the received packets through a feedforward path from a network interface receiver in the network adaptor, through the security offload engine and to the communication protocol offload engine to be reassembled; and
feeding the reassembled packets from the communication protocol offload engine through a feedback path from the communication protocol offload engine to the security offload engine to be decrypted.

30. The article of manufacture of claim 29, wherein said forwarding operation comprises:
feeding the decrypted and reassembled packets through the feedforward path from the security offload engine to the communication protocol offload engine; and
wherein the operations further comprise extracting a data payload from the decrypted and reassembled packets using the communication protocol offload engine.

31. The article of manufacture of claim 22, wherein the operations further comprise:
multiplexing a flow of data packets in the feedforward path from the network interface receiver to the security offload engine and a flow of data packets in the feedback path from the communication protocol offload engine to the security offload engine.

32. The system of claim 21, wherein the logic is further adapted to:
multiplex a flow of data packets in the feedforward path from the network interface receiver to the security offload engine and a flow of data packets in the feedback path from the communication protocol offload engine to the security offload engine.

33. An adaptor, comprising:
a network interface controller adapted to receive fragments of network packets, at least some of the fragments originating from network packets encrypted prior to fragmentation;
a communication protocol offload engine to reassemble the network packets from the received fragments;
a security offload engine to decrypt at least a portion of the reassembled network packets to provide decrypted packets; and
logic adapted to selectively return ast least some of the decrypted packets to the communication protocol offload engine.

34. The adaptor of claim 33 wherein the communication protocol of the communication protocol offload engine is the Transmission Control Protocol (TCP) and Internet Protocol (IP).
